(19) United States
(12) Patent Application Publication
(10) Pub. No.: US 2012/0104871 A1
(43) Pub. Date: May 3, 2012

(54) ENERGY EFFICIENT COMPACT ELECTRONIC TIMER FOR AN ELECTRICAL LOAD

(76) Inventor: Thomas Strothmann, Tucson, AZ (US)

(21) Appl. No.: 13/283,551

(22) Filed: Oct. 27, 2011

Related U.S. Application Data
(60) Provisional application No. 61/455,758, filed on Oct. 27, 2010.

(51) Int. Cl. H01H 7/00

(52) U.S. Cl. 307/141

(57) ABSTRACT

A compact wall-mountable load control device for controlling the power delivered to an electrical load from an AC power source includes: a controllably conductive device coupled in a series electrical connection between the AC power source and the load, the controllably conductive device including a control input; a control circuit operatively coupled to the control input of the controllably conductive device, the control circuit operable to control the conductivity of the controllably conductive device, the control circuit including a timer; a timer adjustment selector operatively coupled to the control circuit; a visual indicator operatively coupled to the control circuit; and a switch operatively connected to the control circuit to provide a user the ability to operate the control circuit using the integral switch. The control circuit includes a timed ON setting, an OFF setting, and an ON setting that bypasses the timer. The timed ON setting may be user adjustable.

### CROSS-REFERENCE TO RELATED APPLICATIONS

This application incorporates by reference and claims priority to U.S. Provisional Patent Application No. 61/455,758 filed Oct. 27, 2010.

### BACKGROUND OF THE INVENTION

The present subject matter relates to load control devices for controlling the duration of power delivered to an electrical load from a source of alternating-current (AC) power, and more particularly, to a compact, wall-mountable, electronic timer for supplying power to a connected electrical load for a predetermined amount of time.

In response to increasing awareness of energy conservation, many lighting control devices, such as dimmers, electronic timers, occupancy sensors, and daylight sensors, provide means for energy management of lighting loads in commercial and residential installations. Specifically, electronic timers operate to turn off a connected electrical load after a predetermined amount of time after the electrical load is turned on. Typically, the electronic timer includes a switching device, such as a relay, coupled in series electrical connection between an AC power source and the electrical load. Often, electronic timers are adapted to be mounted in electrical wall-boxes and are used in rooms, such as bathrooms, where a light or an exhaust fan may be turned on when the room is first in use, and left on after the room is no longer in use. Although designed to save energy, the control circuits in electronic timers of the existing art are continuously connected to power and draw a low level of current even when the load is off. This design aspect is particularly problematic if the electronic load control device fails in a conductive state and the control circuit no longer enables the load to be turned off. Further, many of the timers of the existing art have a complex user interface, so it is not intuitive to an untrained user how to turn the load off in an emergency situation.

For example, one existing wall-mounted electronic timer is the Decora LTB30-1LZ electronic timer manufactured by Leviton Manufacturing Co., Inc. The electronic timer comprises four buttons, each corresponding to a different timeout period, e.g., five minutes, ten minutes, fifteen minutes, and thirty minutes. The buttons are each labeled with the corresponding timeout period. Actuating one of the four buttons turns a connected electrical load on and begins a countdown with the corresponding timeout period. After this period of time expires, the electrical load is turned off. A visual indicator, e.g., a light-emitting diode (LED), is located next to or in each of the buttons and illuminates to indicate how much time is left in the timeout period. For example, if there are nine minutes left until the lighting load is turned off, the visual indicator corresponding to the timeout period of ten minutes will be illuminated. During the last few minutes, e.g., the last two (2) minutes, of the timeout period, the visual indicator next to the bottom button blinks quickly. Further, the electronic timer has an off button located below the other four buttons. When the off button is actuated, the electrical load is immediately turned off.

Another existing wall-mounted electronic timer is an electronic in-wall countdown timer (part number EI210) manufactured by Intermatic Incorporated. This electronic timer has a single button and four visual indicators located in a linear array on a front surface of the timer. Selectable timeout periods are listed beside the visual indicators and include ten minutes, fifteen minutes, thirty minutes, and sixty minutes. Repeatedly pressing the single button cycles the electronic timer between the four different timeout periods and causes the corresponding visual indicator to illuminate. Pressing and holding the single button causes the electronic timer to enter a bypass mode, i.e., the timing function is disabled and the timer will supply power until manually turned off. A fifth visual indicator, which is located below the other four visual indicators, is illuminated when the electronic timer is in the bypass mode.

Typical existing electronic timers have user interfaces that require a high level of cognition to operate and have an unsatisfactory aesthetic appearance. For example, the Leviton electronic timer has several buttons and requires the user to have a basic familiarity with the operation of the switch to turn it on or turn it off. With the Intermatic electronic timer described above, a user must repeatedly press the single button to turn an electrical load on with a long timeout period or to turn off the lighting load. Further, the functional buttons and visual indicators of typical electronic timers are not attractive and do not resemble standard wall switches, especially in a residential installation. Existing electronic timers typically look much different than other lighting controls, such as switches and dimmers that might be mounted next to the electronic timer.

In addition, in many cases, the operation of existing timers may not be intuitive to a new user and the complexity of the design may discourage the adoption of the timer by many users.

Therefore, there is a need for an electronic timer having a very simple user interface that provides an attractive appearance while allowing the user access to multiple features. Further, there is a there is a need for a highly functional timer that is similar in appearance to the other switches and can work within a standard switch plate, which may encourage installation of an energy saving device into public locations otherwise unsuitable for existing timer switches.

### BRIEF SUMMARY OF THE INVENTION

To meet these needs, and others, the present subject matter discloses a compact, wall mountable, load control device for controlling the power delivered to an electrical load from an AC power source, comprising a toggle switch actuator, a controllably conductive device, a controller, and a visual indicator. The controllably conductive device is operatively associated with a control input and is adapted to be coupled in series electrical connection between the power source and the load for controlling the delivery of power to the load. The controller includes a timer and is operatively coupled to the control input of the controllably conductive device to control the conductivity of the device. The toggle switch actuator and the visual indicator are operatively coupled to the controller. The controller is operable to start the timer, which is initialized with a preset timeout period that is set by the user during installation of the load control device, cause the visual indicator to blink during the preset timeout period, control the conductivity of the controllably conductive device so as to enable the delivery of power to the load in response to power being applied to the controller, and control the conductivity of the controllably conductive device so as to prevent the delivery of power to the load when the preset timeout period has elapsed.

According to another embodiment of the present invention, a wall-mountable electrical timer for controlling the power delivered to an electrical load from an AC power source comprises a toggle switch actuator operable to cause the electrical timer to turn on and enter a countdown mode in response to the toggle actuator being placed in the ON position. The load is turned off after a predetermined time period after the load is turned on. The toggle actuator is further operable to cause the electrical timer to enter a bypass mode in response to placing the toggle switch in the OFF position and then back to the ON position within a predetermined amount of time while the countdown timer is active. The load is then indefinitely turned on in a bypass mode. The electronic timer further comprises a visual indicator operable to illuminate in a blinking mode when the electrical timer is in the countdown mode, to illuminate continuously when the electrical timer is in the bypass mode, and to be off when power is no longer applied to the load.

The present invention provides a three wire wall-mountable electrical timer, which is operable to control the power delivered to an electrical load from an AC power source and comprises a toggle switch actuator for turning on the load and a visual indicator. The electrical timer is operable to turn off the load after a preset timeout period after the load is turned on. The visual indicator turns off at the end of the timed cycle to provide visual feedback to the user when the load is off. The toggle switch actuator is wired in series with the controller to totally remove power from the circuit when placed in the OFF position, thereby reducing power consumption of the circuit and providing a high level of reliability and safety during maintenance activities on the load or in the event of component failure wherein the load does not automatically turn off.

The present invention further provides a load control device for controlling the state of an electrical load. The load control device comprises a user-set timer adjustment mechanism for selecting a preset timeout period between a minimum preset timeout period and a maximum preset timeout period, and a power switch, independent of said user-set timer adjustment mechanism, for generating control signals in response to an input from a user. The load control device further comprises control means operatively coupled to said control switch for causing the load to: (1) change from an off state to a countdown state when power is first applied to the controller, wherein the load is turned on for a predetermined amount of time; (2) change from the countdown state to the off state after the preset timeout period has elapsed; (3) change from the countdown state to a bypass state when said input from a user causes a second switch cycle to occur within a predetermined time interval, wherein the load is turned on indefinitely in the bypass state; and (4) change from one of the countdown state or the bypass state to the off state when said toggle switch actuator is turned to the OFF position.

Another embodiment of the present invention enables the remote operation of the electronic timer by using a standard power switch mounted separately from the electronic timer circuit. In this embodiment, the electronic timer and the visual indicator can be mounted within the load or near the load location, e.g., an exhaust fan in the ceiling. The visual indicator can be seen in the grill of the fan directly or through the use of optical fiber embedded in the grill. Operation of this embodiment is similar to the embodiment previously described, comprising the steps of: (1) operating a switch to apply power to the electronic timer; (2) enabling the delivery of power to the load in response to the step of applying power to the electronic timer; (3) discontinuing the delivery of power to the load when a preset timeout period has elapsed; (4) illuminating a visual indicator to blink on and off after the step of enabling the delivery of power to the load, to indicate a timer is being used to control the load; (5) entering a bypass mode in which power is indefinitely provided to the load by turning the power to the electronic timer off and on again within a predetermined amount of time while it is in the countdown mode; and (6) illuminating the visual indicator continuously after the step of entering the bypass mode.

In one example, an electric timer for controlling an electric load includes: a two-position switch operatively coupled in series between an electrical source and a load, wherein the switch is adapted to place the electric timer into a selected one of a plurality of available conditions including: a first condition in which the electrical source is operatively connected to the load; a second condition in which the electrical source is operatively disconnected from the load; and a third condition in which the electrical source is operatively connected to the load for a selected duration of time after which the electrical source is operatively disconnected from the load. The two-position switch may include a controllably conductive device operatively coupled to a control circuit. When the electrical source is operatively disconnected from the load, the control circuit may also be disconnected from the load. In addition, the electric timer may include a visual indicator adapted to signal when the electric timer is in each of the first condition, second condition and third condition.

In another example, a compact wall-mountable load control device for controlling the power delivered to an electrical load from an AC power source, the load control device includes: a controllably conductive device coupled in a series electrical connection between the AC power source and the load, the controllably conductive device including a control input; a control circuit operatively coupled to the control input of the controllably conductive device, the control circuit operable to control the conductivity of the controllably conductive device, the control circuit including a timer; a timer adjustment selector operatively coupled to the control circuit; a visual indicator operatively coupled to the control circuit; and a switch operatively connected to the control circuit to provide a user the ability to operate the control circuit using the integral switch; wherein the control circuit is operable to: control the conductivity of the controllably conductive device so as to enable the delivery of power to the load in response to power being applied to the control circuit; start the timer in response to power being applied to the control circuit, the timer initialized with a preset timeout period; cause a visual indicator to blink while the load is powered and controlled by the timer; and control the conductivity of the controllably conductive device so as to prevent the delivery of power to the load when the preset timeout period has elapsed.

The controllably conductive device may be a bidirectional semiconductor switch or a relay switch. The control circuit may further be operable to cause the electrical timer to enter a bypass mode when the switch is toggled from on to off and on again within a predetermined time span, whereby the load is indefinitely turned on in a bypass mode and the countdown timer is bypassed.

In one example, the visual indicator is illuminated constantly to indicate bypass mode. The visual indicator may be further adapted to illuminate with a first color to indicate a timed period until the preset timeout period has elapsed and to illuminate with a second color when in bypass mode. In addition, the visual indicator may blink more rapidly near the end of the timed cycle to indicate the delivery of power to the load is about to be disabled. The visual indicator may be incorporated into the switch. The control circuit may be a microcontroller. The timer adjustment selector may include user adjustable electrical jumper blocks.

The controllably conductive device, the control circuit, the timer adjustment selector, the visual indicator, and the switch may all be combined in a single housing. Alternatively, the controllably conductive device, the control circuit, the timer adjustment selector, and the visual indicator may be located in one housing, and the switch may be provided in a separate housing.

In still another example, a compact wall-mountable electrical timer, with an integrated power switch, for controlling the power delivered to an electrical load from an AC power source, the electrical timer includes: a toggle actuator, responsive to a single actuation to the ON position to turn the load on for a predetermined time period and turn the load off when the predetermined time period is complete and further responsive to a single actuation to the OFF position to turn the load off.

The toggle actuator may be responsive to being toggled OFF and ON again within a predetermined time to apply power to the load in a bypass mode, wherein the electrical timer is bypassed. The predetermined time period may be a fixed or user adjustable preset timeout period.

An advantage of the electronic timer is it provides a very simple user interface.

Another advantage of the electronic timer is that it may be provided in a form factor similar to a standard light switch.

A further advantage of the electronic timer is that it may include a toggle switch including an LED indicator light.

Still another advantage of the electronic timer is that it allows a user to manually shut off the circuit.

Yet another advantage of the electronic timer is, when the switch is in the “off position,” the control circuit does not use power.

Another advantage of the electronic timer is the timer can be controlled rom a standard wall switch without sacrificing functionality.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a front view of an example of an electronic timer as described herein.

FIG. 2 is a side view of the electronic timer of FIG. 1.

FIG. 3 is a flowchart illustrating an example of a timer procedure that may be executed by the controller of the electronic timer of FIG. 1.

FIG. 4 is an isometric view of a small enclosure containing the electronic timer circuits as described herein without an integral power switch.

FIG. 5 is a simplified block diagram of an example of a timer circuit that may be implemented in the electronic timer of FIG. 1 using a micro controller.

FIG. 6 is a simplified block diagram of an example of a timer circuit that may be implemented in the electronic timer of FIG. 1 using standard logic and timer circuits.

### DETAILED DESCRIPTION OF THE PREFERRED EMBODIMENTS

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

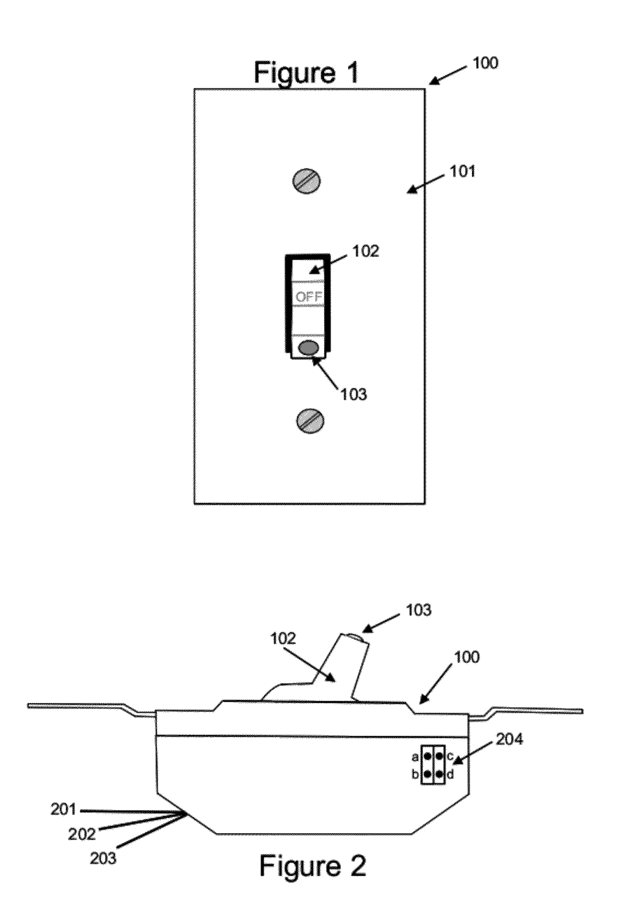

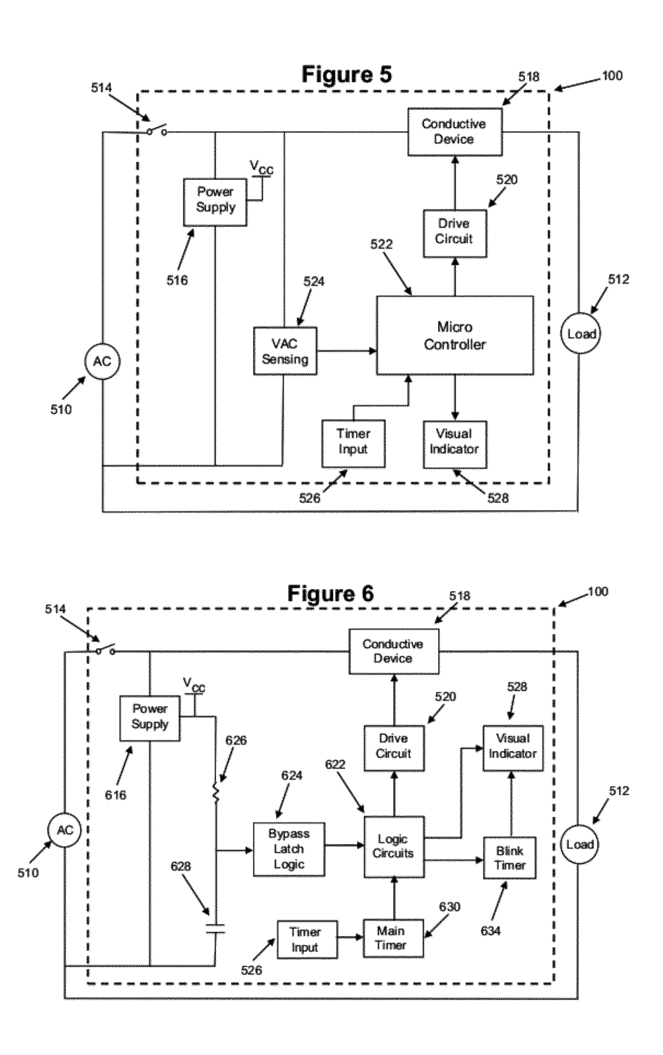

FIG. 1 is a front view of an electronic timer 100 according to the present invention. The electronic timer 100 includes a faceplate 101 and a toggle actuator 102 protruding through an opening of the faceplate 101. The electronic timer 100 further includes a visual indicator element 103 visible in the toggle actuator 102. As described further herein, actuations of the toggle actuator 102 generally turns off and on a connected electrical load, for example, a lighting load 512 (FIGS. 5 and 6) or a motor load, such as an exhaust fan. The electronic timer 100 is operable to turn off the lighting load 512 at the end of the preset timeout period after the lighting load 512 is turned on. The operation of the electronic timer 100 in response to actuations of the toggle actuator 102 is described in greater detail below.

A user can turn on the lighting load 512 (FIGS. 5 and 6) by actuating the toggle actuator 102 to the ON position. At this time, the electronic timer 100 enters a countdown mode and starts a countdown timer having an initial value equal to the desired timeout period. The electronic timer 100 illuminates the visual indicator 103 to blink on and off to indicate the load is switched on in a timer mode (e.g., on for one-half second and off for one-half second).

When there is a small amount of time left in the countdown timer, e.g., one (1) minute, the electronic timer 100 provides a pre-off visual feedback by blinking the visual indicator quickly, i.e., at a second rate faster than the first rate (e.g., on for one-fourth second and off for one-fourth second), to warn the user that the lighting load 512 (FIGS. 5 and 6) is about to turn off.

When the countdown timer expires, i.e., after the desired timeout period has elapsed, the electronic timer 100 turns the lighting load 512 (FIGS. 5 and 6) off. Before the countdown timer expires and the electronic timer 100 turns the lighting load 512 off, the user may actuate the toggle actuator 102 to the OFF position to manually turn the lighting load 512 off.

The electronic timer 100 is also operable to enter a bypass mode in which the countdown timer is disabled and power is continuously (though indefinitely) provided to the lighting load 512 (FIGS. 5 and 6). When the electronic timer 100 is in the countdown mode, the user may actuate the toggle actuator off and then on again within a predetermined time period, (e.g., within two seconds), to cause the timer to enter a bypass mode and disable the countdown timer. When in a bypass mode, the visual indicator 103 is lit continuously and does not blink and the load remains on until the toggle actuator is placed in the OFF position.

In the event the user chooses to turn off the toggle actuator 102 before the timed period has expired, the electronic timer 100 has the appearance and function of a standard wall switch.

Turning now to FIG. 2, a side view of the electronic timer 100 is shown. As described above with respect to FIG. 1, the electronic timer 100 includes a toggle actuator 102 and a visual indicator element 103 visible in the tip of the toggle actuator 102. The visual indicator element 103 may be a visual indicator element such as those disclosed in U.S. patent application Ser. No. 12/777,438, filed on May 11, 2010, the entirety of which is incorporated herein by reference.

The electronic timer 100 further includes recessed electrical pins 204 that can be connected with electrical jumper blocks to preset the countdown timer and three wires 201, 202, and 203 protruding from the body of the electronic timer 100. In one embodiment, a first wire 201 is connected to AC line voltage, a second wire 202 is the switched AC line voltage that is connected to the load from the electronic timer 100, and a third wire 203 is connected to AC neutral.

During installation of the electronic timer 100, a user of the electronic timer 100 may set a desired amount of time for the preset timeout period, i.e., the amount of time that the lighting load will remain on after the lighting load is turned on. The user may adjust the placement of electrical jumper blocks to select one of a plurality of predetermined values of the timeout period, e.g., five minutes, ten minutes, fifteen minutes, or twenty minutes. The selection can be realized by placement of electrical jumper blocks onto the recessed electrical connections 204 mounted into the side of the timer. As an example, no electrical jumper blocks result in a preset time of five minutes, placement of a electrical jumper between pins “a” and “b” selects a preset time of ten minutes, placement of a second electrical jumper between pins “c” and “d” selects a preset time of fifteen minutes, and placement of a single electrical jumper between pins “c” and “d” selects a preset time of twenty minutes.

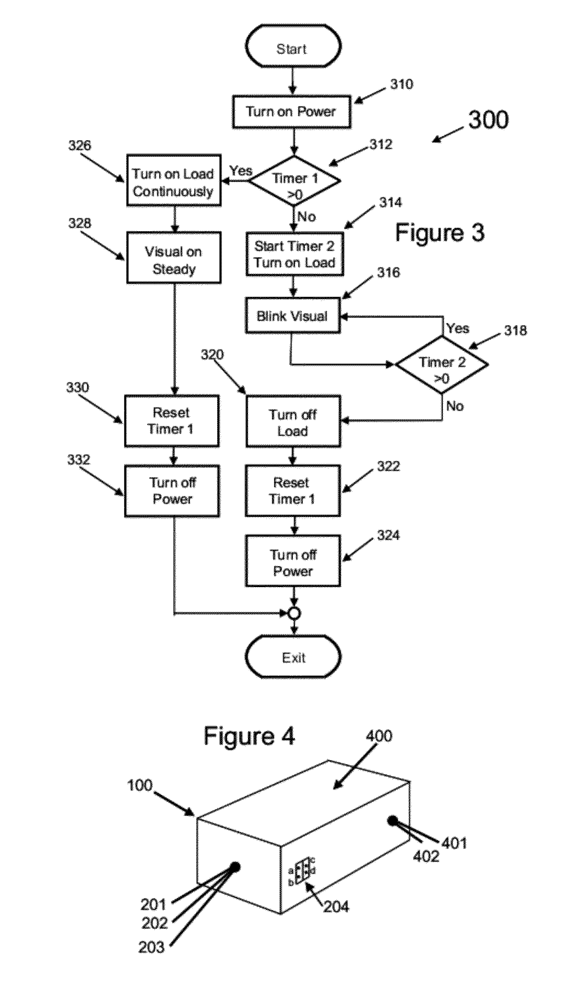

FIG. 3 is a flowchart of a timer procedure 300 that may be executed by the controller 522 (FIG. 5) to provide the benefits of the solutions described herein. The controller 522 uses a countdown timer to determine when the preset timeout period expires to turn off the lighting load 512 (FIG. 5).

In step 310 the power is turned on with the toggle actuator switch 514 (FIG. 5). In step 312 the status of Timer 1 is checked and, if Timer 1 is greater than zero, Timer 2 is bypassed and power is applied to the load 512 (FIG. 5) continuously in step 326. The visual indicator 103 is lit continuously without blinking in step 328. Timer 1 is reset in step 330. This allows the switch 514 (FIG. 5) to be turned off and on again immediately without causing the timer circuit to bypass the countdown timer.

If Timer 1 is not greater than zero in step 312, Timer 2 is started and power is applied to the load 512 (FIG. 5) in step 314. The visual indicator 103 begins to blink in step 316. Timer 2 is checked in step 318 and, if Timer 2 is greater than zero, the flow loops back to 316 and the Visual Indicator continues to blink. If Timer 2 is not greater than zero in step 318, the Load 512 (FIG. 5) is turned off in step 320. After the load 512 is turned off, Timer 1 is reset in Step 322. This allows the switch 514 (FIG. 5) to be turned off and on again immediately without causing the timer circuit to bypass the countdown timer.

Power is turned off in steps 332 and 324 by turning off switch 514 (FIG. 5). This completely removes power from the timer circuit, completing the flowchart sequence.

Although this flowchart has been described with the use of the microcontroller in FIG. 5, it is also applicable for use with the timer and logic circuits described in FIG. 6, as well as other embodiments suitable for providing the benefits of the solutions presented herein.

FIG. 4 is a perspective view of an electronic timer 100 that does not include an integral toggle actuator switch 102. This embodiment is designed to be mounted at the load location, e.g., on an exhaust fan housing. The electronic timer 100 comprises an enclosure 400 for the electronic timer, recessed electrical pins 204 that can be connected with electrical jumper blocks to preset the time for the countdown timer, and other electrical connections. Three wires 201, 202, and 203 protrude from the body of the electronic timer 100. In one embodiment, the first wire 201 is connected to switched AC line voltage from a remotely installed power switch, the second wire 202 is the switched AC line voltage that is connected to the load from the output of the electronic timer 100, and the third wire 203 is connected to AC neutral. Two additional wires 401 and 402 protrude from the body of the electronic timer 100. In one embodiment, the fourth wire 401 is connected to the positive terminal of an LED visual indicator and the fifth wire 402 is connected to the negative terminal of an LED visual indicator. The visual indicator is mounted in a position to be visible to the operator of the remote switch, e.g., the grill of an exhaust fan.

During installation of the electronic timer 100, a user of the electronic timer 100 may set a desired amount of time for the preset timeout period, i.e., the amount of time that the load will remain on after the load is turned on. The user may adjust the placement of electrical jumper blocks to select one of a plurality of predetermined values of the timeout period, e.g., five minutes, ten minutes, fifteen minutes, or twenty minutes. The selection can be realized by placement of electrical jumper blocks onto the recessed electrical connections 204 mounted into the side of the timer 100. As an example, no electrical jumper blocks result in a preset time of five minutes, placement of an electrical jumper between pins “a” and “b” selects a preset time of ten minutes, placement of a second electrical jumper between pins “c” and “d” selects a preset time of fifteen minutes, and placement of a single electrical jumper between pins “c” and “d” selects a preset time of twenty minutes.

FIG. 5 illustrates a simplified block diagram of an embodiment of the electronic timer 100. The electronic timer 100 shown in FIG. 5 is coupled in series electrical connection between an AC power source 510 and the load 512. The toggle actuator 514 switches the AC voltage on and off, and thereby supplies power to the electronic timer circuit and the load 512. The electronic timer 100 includes the switch 514 wired in series with controllably conductive device 518 for timed control of the power delivered to the load 512. The controllably conductive device 518 may comprise a relay, or any suitable type of bidirectional semiconductor switch, such as, for example, a triac. The controllably conductive device 518 includes a control input coupled to a drive circuit 520. The input from the drive circuit 520 renders the controllably conductive device 518 conductive or non-conductive, which in turn controls the power supplied to the load 512.

The drive circuit 520 provides control inputs to the controllably conductive device 518 in response to command signals from a controller 522. The controller 522 is preferably implemented as a microcontroller, but may be any suitable processing device, such as a programmable logic device (PLD), a microprocessor, or an application specific integrated circuit (ASIC). The controller 522 receives inputs from the toggle actuator 514, the VAC sensing 524, and the timer adjustment input 526 and controls output to the visual indicator 528 and the drive circuit 520. When controller timer is in count down mode, the visual indicator blinks while power is applied to the load 512 and is not lit when power to the load 512 is turned off. The controller 522 is operable to turn on (i.e., enabling power to be delivered to) the lighting load 512, and to turn off (discontinue delivering power to) the lighting load 512 when the countdown timer reaches zero. The controller 522 preferably includes a timer, i.e., a countdown timer, for counting down the preset timeout period. A power supply 516 generates a direct-current (DC) voltage Vcc for powering the controller 522 and other low-voltage circuitry of the electronic timer 100. The power supply 516 continues to supply DC voltage to the electronic timer circuit for a short period of time, e.g. three seconds, after the AC voltage is shut off, through the use of a charged capacitor.

An AC voltage detector 524 determines the presence the input AC waveform from the AC power supply 510. If the AC is turned off and then turned back on again within a predetermined time, e.g. two seconds, the controller countdown timer is bypassed and the controller 522 enters a bypass mode wherein power is applied to the load 512 continuously. The visual indicator 103 is lit continuously without blinking when the controller timer is in the bypass mode.

The controller 522 provides the control inputs to the drive circuit 520 to operate the controllably conductive device 518 (i.e., to provide or block voltage from the AC power supply 510 to the lighting load 512).

The bypass mode may be disabled, for example, by using an advanced programming procedure of the electronic timer 100. Accordingly, when the bypass mode is disabled, the user cannot cause the electronic timer 100 to enter the bypass mode by using the toggle actuator 102. Further, the electronic timer 100 may be programmed to operate with a “locked” or “protected” preset timeout period, i.e., the preset timeout period cannot be changed, via the electrical jumper blocks.

The power switch 514 can be mounted separately from the rest of the electronic timer circuits 100 to enable the use of a standard wall switch to control the timer 100. In this embodiment the electronic timer circuit and visual indicator can be mounted near to or within the load, e.g., an exhaust fan, and the operation of the circuit as described in FIG. 5 is otherwise unchanged.

FIG. 6 provides another simplified block diagram of an example of the electronic timer 100. The electronic timer 100 is coupled in series electrical connection between an AC power source 510 and the load 512. The toggle actuator 514 switches the AC voltage on and off, thereby supplying power to the electronic timer circuit and the load. The electronic timer 100 comprises the switch 514 wired in series with controllably conductive device 518 for timed control of the power delivered to the load 512. The controllably conductive device 518 may comprise a relay, or any suitable type of bidirectional semiconductor switch, such as, for example, a triac. The controllably conductive device 518 includes a control input coupled to a drive circuit 520. The input to the drive circuit 520 renders the controllably conductive device 518 conductive or non-conductive, which in turn controls the power supplied to the load 512.

The drive circuit 520 provides control inputs to the controllably conductive device 518 in response to command signals from logic circuits in 622. The logic circuits in 622 are preferably independent NAND and NOR gates. The logic circuits receive inputs from the bypass latch logic 624 and the main timer 630 and control the output to the visual indicator 528 and the drive circuit 520. When main timer 630 is in count down mode, the visual indicator blinks based on power applied by the blink timer 634. The visual indicator is not lit when power to the load 512 is turned off. The logic circuits 622 are operable to turn on (i.e., enabling power to be delivered to) the lighting load 512, and to turn off (discontinue delivering power to) the lighting load 512 in response to the input received from the main timer 630 and the bypass latch logic 624. A power supply 616 generates a direct-current (DC) voltage Vcc for powering the logic circuits 622 and other low-voltage circuitry of the electronic timer 100.

An RC timer is created with resistor 626 and capacitor 628. This RC timer maintains a “high” logic signal for a short period of time, e.g., two seconds, after the AC is turned off. If the AC is turned on again while the logic signal is “high”, the bypass latch Logic 624 provides an input to the logic circuits 622 to bypass the timer input and apply power to the load 512 continuously. The visual indicator 528 is lit continuously without blinking by the logic circuits 622 when the countdown timer is in the bypass mode. When the countdown time is complete, or the timer is placed in bypass mode, the circuits in the bypass latch discharge the capacitor 628 to prevent the circuit from entering a bypass mode if the AC power is rapidly switched off and on again.

The logic circuits 622 provide the control input to the drive circuit 520 to operate the controllably conductive device 518 (i.e., to provide or block voltage from the AC power supply 510 to the lighting load 512).

The bypass mode may be disabled, for example, by disabling the bypass latch 624. Accordingly, when the bypass latch 624 is disabled, the user cannot cause the electronic timer 100 to enter the bypass mode by using the toggle actuator 102. Further, the electronic timer 100 may be set to operate with a “locked” or “protected” preset timeout period, i.e., the preset timeout period cannot be changed, via the electrical jumper blocks.

The power switch 514 can be mounted separately from the rest of the electronic timer circuits 100 to enable the use of a standard wall switch to control the timer. In this embodiment the electronic timer circuit and visual indicator can be mounted near to or within the load, e.g. an exhaust fan, and the operation of the circuit as described in FIG. 6 is otherwise unchanged.

Although the present invention has been described in relation to particular embodiments thereof, many other variations and modifications and other uses will become apparent to those skilled in the art. Accordingly, the present invention should be limited only by the appended claims.

We claim:

1. An electric timer for controlling an electric load comprising:
a two-position switch operatively coupled in series between an electrical source and a load, wherein the switch is adapted to place the electric timer into a selected one of a plurality of available conditions including:
a first condition in which the electrical source is operatively connected to the load;
a second condition in which the electrical source is operatively disconnected from the load; and
a third condition in which the electrical source is operatively connected to the load for a selected duration of time after which the electrical source is operatively disconnected from the load.

2. The electric timer of claim 1 wherein the two-position switch includes a controllably conductive device operatively coupled to a control circuit.

3. The electric timer of claim 2 wherein, when the electrical source is operatively disconnected from the load, the control circuit is also disconnected from the load.

4. The electric timer of claim 1 further including a visual indicator adapted to signal when the electric timer is in each of the first condition, second condition and third condition.

5. A compact wall-mountable load control device for controlling the power delivered to an electrical load from an AC power source, the load control device comprising:
a controllably conductive device coupled in a series electrical connection between the AC power source and the load, the controllably conductive device including a control input;
a control circuit operatively coupled to the control input of the controllably conductive device, the control circuit operable to control the conductivity of the controllably conductive device, the control circuit including a timer;
a timer adjustment selector operatively coupled to the control circuit;
a visual indicator operatively coupled to the control circuit; and
a switch operatively connected to the control circuit to provide a user the ability to operate the control circuit using the integral switch;
wherein the control circuit is operable to:
control the conductivity of the controllably conductive device so as to enable the delivery of power to the load in response to power being applied to the control circuit;
start the timer in response to power being applied to the control circuit, the timer initialized with a preset timeout period;
cause a visual indicator to blink while the load is powered and controlled by the timer; and
control the conductivity of the controllably conductive device so as to prevent the delivery of power to the load when the preset timeout period has elapsed.

6. The load control device of claim 5 wherein the controllably conductive device comprises a bidirectional semiconductor switch.

7. The load control device of claim 5 wherein the controllably conductive device comprises a relay switch.

8. The load control device of claim 5 wherein the control circuit is further operable to cause the electrical timer to enter a bypass mode when the switch is toggled from on to off and on again within a predetermined time span, whereby the load is indefinitely turned on in a bypass mode and the countdown timer is bypassed.

9. The load control device of claim 8 wherein the visual indicator is illuminated constantly to indicate bypass mode.

10. The load control device of claim 8 wherein the visual indicator is adapted to illuminate with a first color to indicate a timed period until the preset timeout period has elapsed and to illuminate with a second color when in bypass mode.

11. The load control device of claim 5 wherein the visual indicator blinks more rapidly near the end of the timed cycle to indicate the delivery of power to the load is about to be disabled.

12. The load control device of claim 5 wherein the visual indicator is incorporated into the switch.

13. The load control device of claim 5 wherein the control circuit comprises a microcontroller.

14. The load control device of claim 5 wherein the timer adjustment selector includes user adjustable electrical jumper blocks.

15. The load control device of claim 5 wherein the controllably conductive device, the control circuit, the timer adjustment selector, the visual indicator, and the switch are combined in a single housing.

16. The load control device of claim 5 the controllably conductive device, the control circuit, the timer adjustment selector, and the visual indicator are located in one housing, and the switch is provided in a separate housing.

17. A compact wall-mountable electrical timer, with an integrated power switch, for controlling the power delivered to an electrical load from an AC power source, the electrical timer comprising:
a toggle actuator, responsive to a single actuation to the ON position to turn the load on for a predetermined time period and turn the load off when the predetermined time period is complete and further responsive to a single actuation to the OFF position to turn the load off.

18. The electrical timer of claim 17, wherein the toggle actuator is responsive to being toggled OFF and ON again within a predetermined time to apply power to the load in a bypass mode, wherein the electrical timer is bypassed.

19. The electrical timer of claim 17, wherein the predetermined time period comprises a fixed preset timeout period.

20. The electrical timer of claim 17 wherein the predetermined time period comprises a user adjustable preset timeout period.
